(19) United States
(12) Patent Application Publication
(10) Pub. No.: US 2011/0168665 A1
(43) Pub. Date: Jul. 14, 2011

(54) Creation of mirror-image patterns by imprint and image tone reversal

(76) Inventors: Thomas Robert Albrecht, San Jose, CA (US); Zvonimir Z. Bandic, San Jose, CA (US)

(21) Appl. No.: 13/065,035

(22) Filed: Mar. 11, 2011

Related U.S. Application Data
(62) Division of application No. 12/220,258, filed on Jul. 22, 2008.

(51) Int. Cl. G11B 5/712; B29C 33/42

(52) U.S. Cl. 216/12; 264/220

(57) ABSTRACT

Mirror-image patterns for use one patterned media. Methods are implemented to create a mirror-image on the top and bottom of a media disk. These mirror images simplify the creation of electronics for patterned media. Further, the methods allow for a single e-beam master disk to be used to create the stamper for the top and the bottom of the media disk.

### RELATED APPLICATION

The patent application is a divisional of a co-pending U.S. patent application Ser. No. 12/220,258, and filed on Jul. 22, 2008, which is incorporated by reference herein.

### BACKGROUND OF THE INVENTION

The heart of a computer's long term memory is an assembly that is referred to as a magnetic disk drive. The magnetic disk drive includes a rotating magnetic media (disk), write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider into contact with the surface of the disk when the disk is not rotating but, when the disk rotates, air is swirled by the rotating disk. When the slider rides on the air bearing, the write and read heads are employed for writing magnetic impressions to and reading magnetic impressions from the rotating disk. The read and write heads are connected to processing circuitry that operates according to a computer program to implement the writing and reading functions.

Patterned magnetic recording media has been proposed to increase the bit density in magnetic recording data storage, such as hard disk drives. In magnetic patterned media, the magnetic material is patterned into small magnetically isolated blocks or islands such that there is a single magnetic domain in each island or “bit”. The single magnetic domains can be a single grain or consist of a few strongly coupled grains that switch magnetic states in concert as a single magnetic volume. This is in contrast to conventional continuous media wherein a single “bit” may have multiple magnetically independent grains or multiple independent clusters of grains. U.S. Pat. No. 5,820,769 is representative of various types of patterned media and their methods of fabrication. A description of magnetic recording systems with patterned media and their associated challenges is presented by R. L. White et al., “Patterned Media: A Viable Route to 50 Gbit/in² and Up for Magnetic Recording?”, IEEE Transactions on Magnetics, Vol. 33, No. 1, January 1997, 990-995. A step between patterned media and continuous media is discreet track media, where a pattern of discreet tracks is patterned onto a media.

Current plans for production of patterned media include creating a “gold” master disk at high cost and expense. From the “gold” master disk, several “silver” production masters are created. Lastly, production disks that are used in hard disk drives are created from the “silver” disks. Of course, a process having more types of masters between the “silver” disks and the production disks is possible. However, these “gold” and “silver” disks can only be used to make one side of a patterned media. Using the same stamp for both sides of a media would lead to difficulties in constructing the electronics and servo patterns for the hard disk drive that uses the media. What is needed is an efficient way to pattern both sides of a patterned media in a manner that allows for ease of construction of the electronics and servo patterns for a hard disk drive.

### SUMMARY OF THE INVENTION

Described are methods for patterning both sides of a patterned media for hard disk drives that allows for ease of construction of the electronics and servo patterns for a hard disk drive.

One method of patterning both sides of a patterned media is by a process for creating a mirror image pattern. The mirror image is created by performing a topographic imprint and a tone reversal process. For patterned media, this can be accomplished by creating a first topographic master pattern by e-beam lithography followed by topographic etching using the e-beam pattern either directly or indirectly as the etching mask. These steps are then followed by nanoimprinting this topographic master pattern to form a mirror image negative tone topographic replica of the master pattern. Next, there is a tone reversal step, and then a subsequent etching of a second substrate to form a positive-tone mirror image replica of the original topographic master pattern.

Discreet track media (DTM), as a subset of patterned media, will also benefit from such a mirror image patterning process.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a hard disk drive with a cover of the hard disk drive removed.

FIG. 2 is an image of the top and bottom surfaces of a disk including the servo patterns on the disk and detailed images thereof.

FIG. 3 is a view of the contents of sector headers that are located next to the servo patterns on the disk.

FIG. 4 is a close-up of a narrow radial range of a single sector header wedge.

FIG. 5 shows the step of performing e-beam lithography on a circular transparent substrate.

FIG. 6a shows a resist pattern being transformed into topography on the surface of the substrate by using the e-beam resist as an etch mask for reactive ion etching.

FIG. 6b shows a master mold being inverted and pressed against a second substrate during a UV-cure nanoimprinting process.

FIG. 7 shows a lift-off tone reversal process.

FIG. 8 shows a S-FIL/R tone reversal process.

### DETAILED DESCRIPTION

The following description is of the best embodiments presently contemplated for carrying out this invention. This description is made for the purpose of illustrating the general principles of this invention and is not meant to limit the inventive concepts claimed herein.

Patterned media disks include circular tracks with individual magnetically isolated islands for data storage, interspersed with pre-patterned sector header information that will include track-following servo patterns, track IDs, synchronization patterns, and other features. While the patterns of data islands on circular tracks may be identical for both sides of the disk, sector headers are generally unique for each sides of the disk. They are unique because the direction of rotation of the disk as viewed from the top of a conventional hard disk drive is counter-clockwise and from the bottom clockwise.

The reversal of rotation direction as viewed from the top and bottom of the hard disk drive has two consequences. First, the order of events within the sector header is reversed. Secondly, the macroscopic arc followed by the sector headers is reversed.

The macroscopic arc is generally chosen so that the time interval between successive sector headers passing under a head of the hard disk drive remains fixed, regardless of the track the head is located. Therefore, as the drive moves the heads to various tracks, the timing intervals between sectors remains constant. The constant timing intervals between sectors, greatly simplifies the design of the head-positioning servo system since a constant servo sampling rate is achieved regardless of head motion. To achieve a constant timing interval between sectors, the sector headers follow arcs whose center of rotation is determined by the actuator pivot location for each sector of the disk.

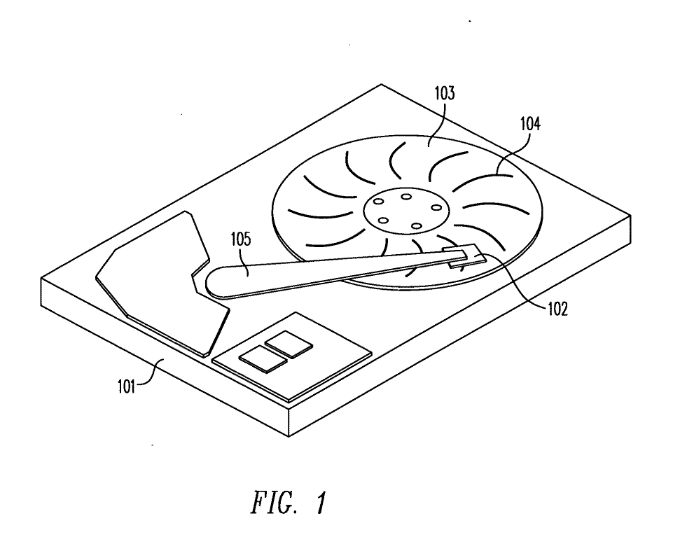

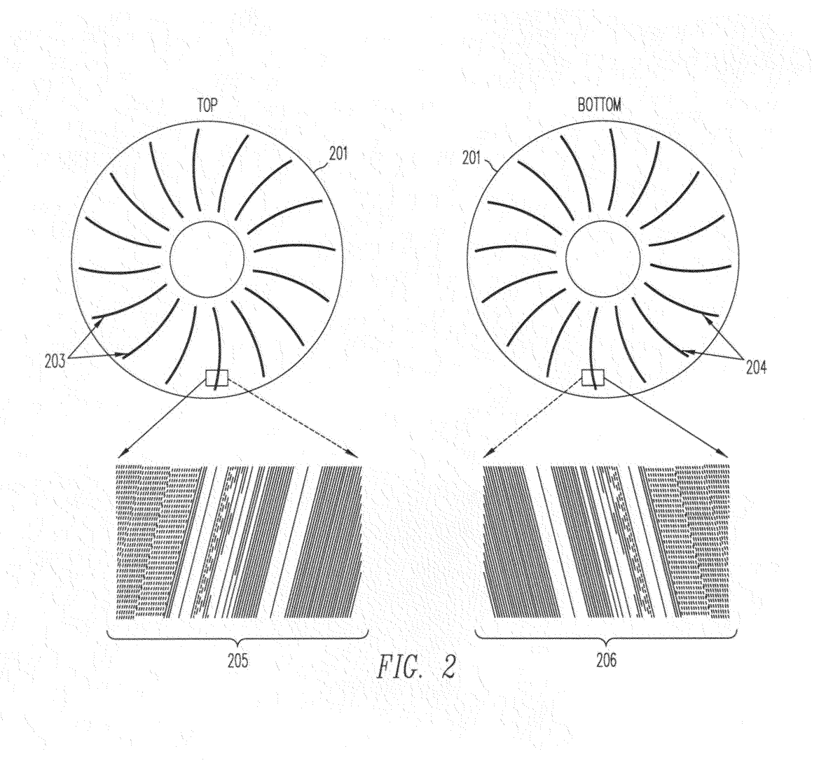

FIG. 1 is a hard disk drive 101 with a cover of the hard disk drive removed. It includes a magnetic read/write head 102, disk 103 and actuator pivot 105. As can be seen, the servo patterns 104 follow arcs of constant radius from the actuator pivot 105. The macroscopic pattern arcs for the top and bottom of the disk then are mirror images of one another as shown in FIG. 2. The top of the disk 201 has servo patterns 203 that are the mirror images of the bottom of the disk 202 with servo patterns 204. Partial detailed views of each side of the servo pattern of the disk are provided as top side servo pattern 205 and bottom side servo pattern 206 respectively.

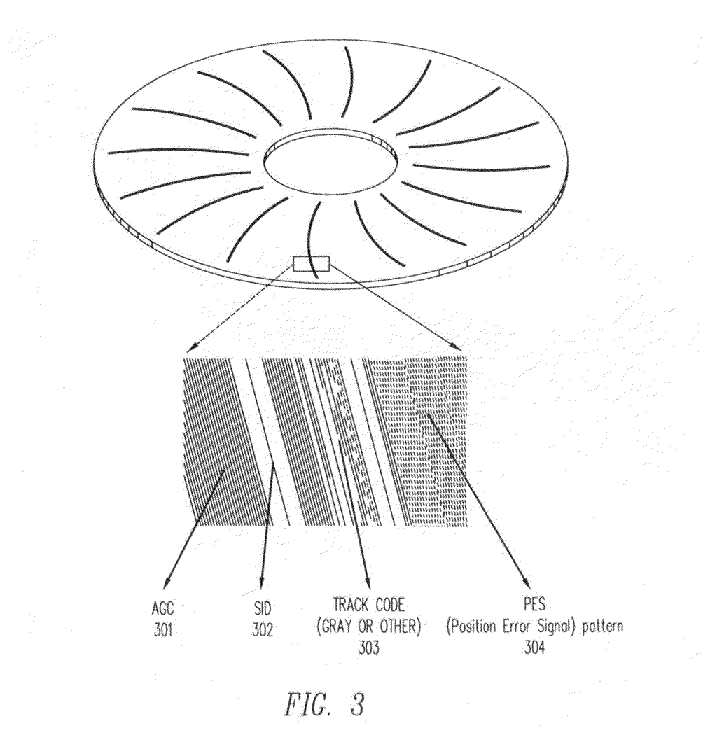

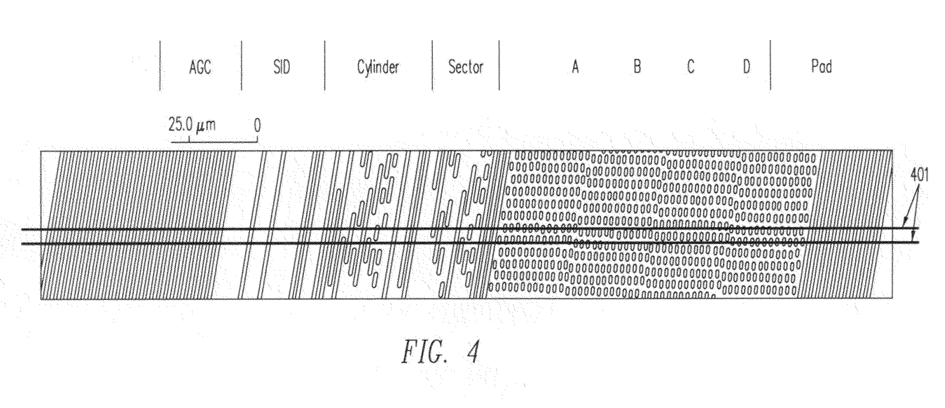

FIG. 3 is a view of the contents of sector headers that include the servo patterns on the disk. The sector headers (shown here as straight wedges for simplification, although they are really arcs as above) are made up of a combination of various types of patterns. These patterns are the Automatic Gain Control pattern 301, SID pattern 302, track code pattern 303 and fine position error signal pattern 304. FIG. 4 is a close-up of a narrow radial range of a single sector header wedge. The parallel lines 401 indicate the position of the centers of two adjacent data tracks. Past the ends of the sector header pattern, each track is made up of a long string of magnetic islands for the data section of the sector. It is useful to have mirror images of these servo patterns, sector headers, data islands and any other features on the top and bottom of a patterned media disk. For example, the cylinder number will be properly mapped for each radial value, and the sector number sequence will remain correct as well.

Instead of creating two mirror image patterns from scratch by e-beam lithography, considerable savings in time and cost can be achieved by creating the mirror image pattern from a single pattern. In addition, a second master created by e-beam lithography may introduce some small unwanted differences between the imprinted patterns on both sides of a disk since the masters were made with different e-beam lithography runs.

Creating the mirror images of a pattern can be completed in two steps. The first step is the creation of a topographic imprint replica of a first pattern. Second, a negative tone replica of the topographic imprint replica created in the first step is created.

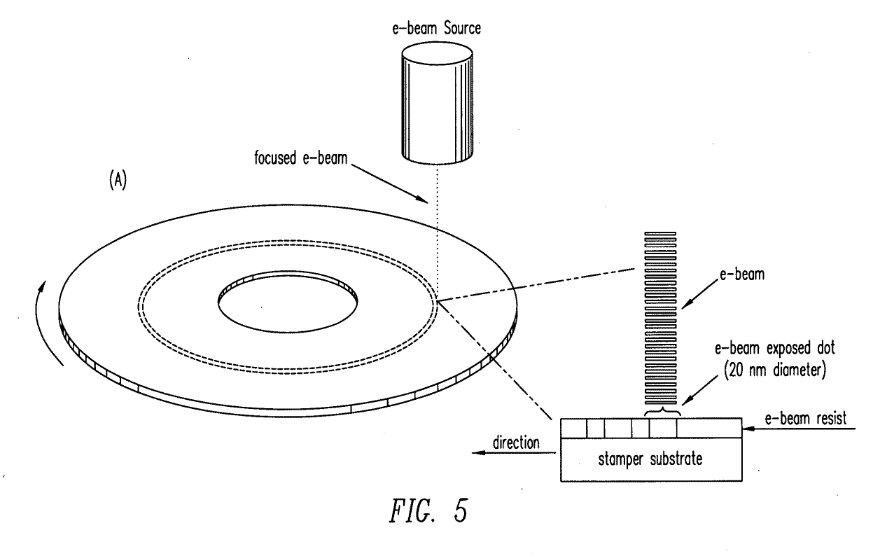

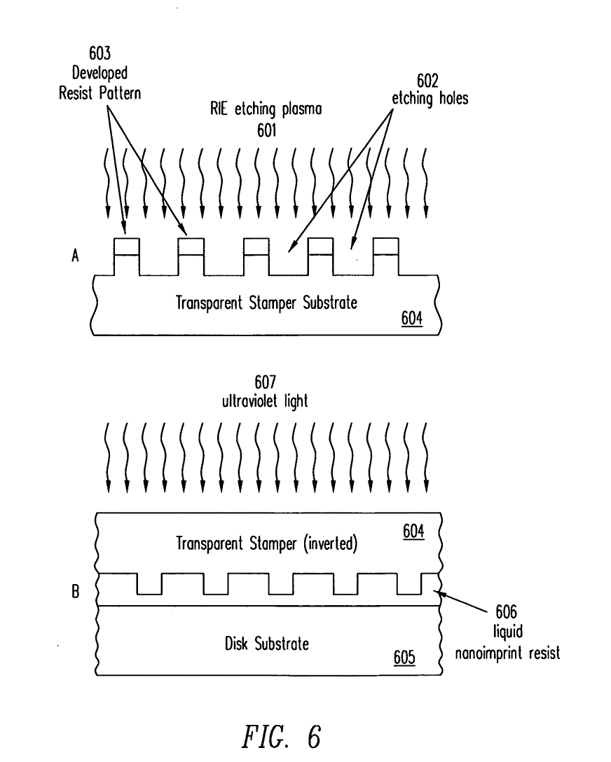

Imprint replication (such as nanoimprinting) by its very nature creates a mirror-image negative tone replica of an original topographic master pattern, also called a “mold” “template” or “stamper”. This process of creating a topographic imprint replica is shown in FIGS. 5 and 6.

FIG. 5 shows the step of performing e-beam lithography on a circular transparent substrate, which could be a “gold” disk. In this example, the e-beam lithography creates patterns of holes in an e-beam resist after developing. FIG. 6a shows the resist pattern of resist 603 being transformed into topography on the surface of the substrate by using the e-beam resist as an etch mask for reactive ion etching with an etching plasma 601, which creates holes 602 on the surface of the substrate. After stripping the resist, the master mold 604 is complete. Further, the master mold is typically made of a transparent material. FIG. 6b show the master mold 604 being inverted and pressed against a second, or disk, substrate 605, with a film liquid photo-curable nanoimprinting resist 606 in between. The liquid resist 606 flows into the holes on the master mold 604 and conforms to the topographic pattern on the surface of the master mold 604. The liquid resist 606 is cured by exposure to ultraviolet light 607 shining through the transparent master mold 604, which turns the resist into a solid 606. After curing, the master mold 604 is pulled away from the cured resist 606, leaving solid resist on the surface of the second substrate 605. This resist is a negative tone replica of the pattern on the master mold 604. In other words, there is a pattern of protruding pillars on the surface of the second substrate 605 corresponding to the pattern of holes on the master mold 604. Also, this pattern is a mirror image of the master, by virtue of the fact that a pattern on the bottom of the master mold 604 has created a pattern on the top of the second substrate 606. Thus, a topographic imprint replica is created.

To create a positive-tone mirror-image replica of the original master pattern, a tone-reversal process is employed which does not mirror the image once again. Two methods for creating a positive-tone mirror-image replica of the original master pattern are:

(1) a lift-off tone reversal process followed by etching; and

(2) a planarization tone-reversal process.

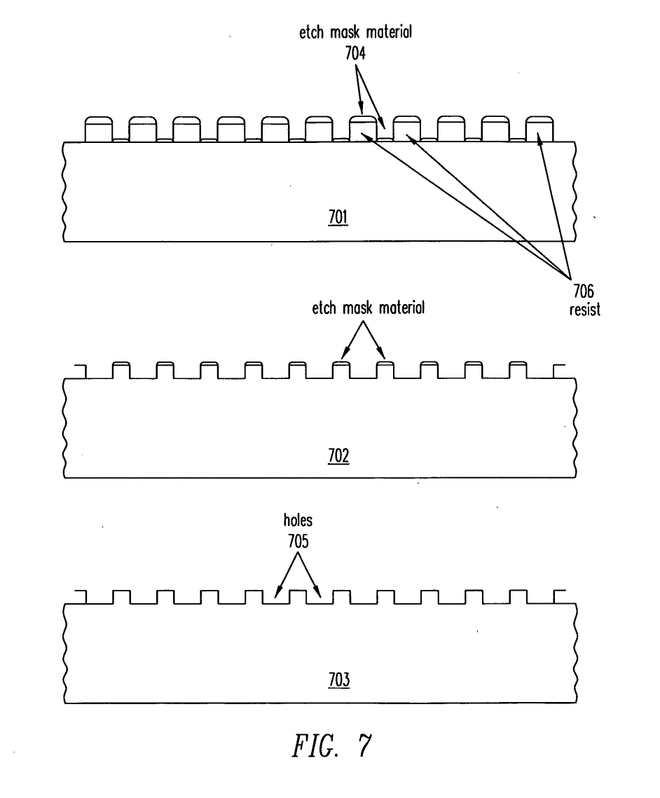

FIG. 7 shows the lift-off tone reversal process. A resist is coated on a substrate.

A stamper with a mirror image (i.e. topographic imprint replica) of the master, like that of the substrate 606, is then used to stamp the resist coated substrate. The resist coated substrate is then cured in a curing process. Then a brief resist etch (e.g., oxygen plasma etch) removes enough of the cured resist so that areas of thin resist between the resist pillars 706 is cleared of resist and forms a cured resist pattern. Then, as shown in 701, an etch mask material 704, such as a metal, is deposited in a directional process that deposits material primarily on exposed upward-facing surfaces (and not on the sidewalls of the resist pillars).

The resist is then removed by a selective wet or dry etch process, causing the etch mask material on top of the resist pillars also to be removed, leaving only the etch mask material on the surface of the substrate surrounding where the pillars were located. A top view at this point would reveal a continuous sheet of etch mask material with holes in it where the pillars were located. Next, as shown in 702, the remaining etch mask material serves as an etch mask for anisotropic reactive ion etching of the substrate, which creates holes 705 in the substrate. Another selective etch process is used to remove the remaining etch mask material, leaving the substrate with holes in the surface as shown in 703. This process thus creates a positive-tone mirror image replica mold.

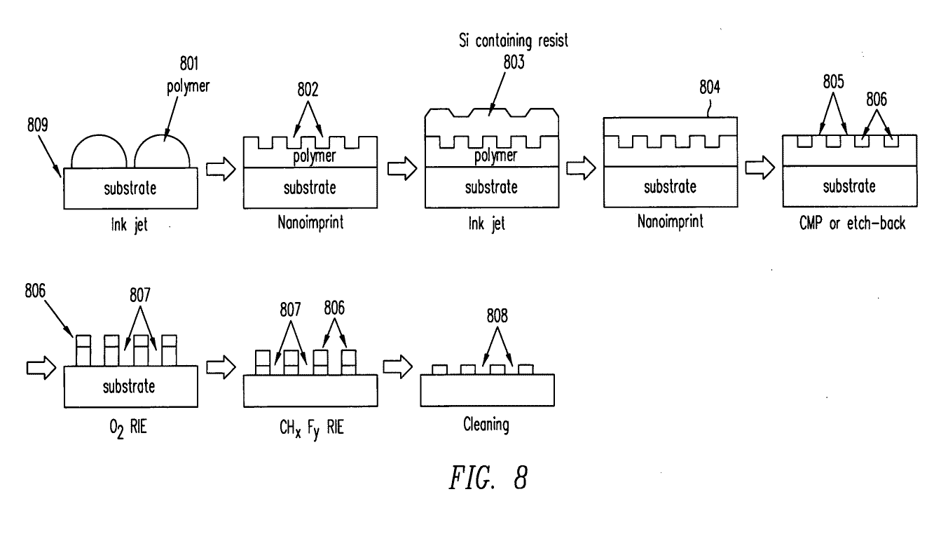

A positive-tone mirror image replica mold can also be created by using a planarization tone reversal process, such as the “S-FIL/R” process for use with nanoimprinting. The S-FIL/R process is shown in FIG. 8.

In the S-FIL/R process as shown in FIG. 8, a UV-curable resist material 801, such as a polymer, is dispensed with an ink jet on the substrate, followed by nanoimprinting with the master mold 602, leaving protruding resist pillars 802. Then, another liquid 803 (silicon-containing, UV-curable resist in the example above) is applied and planarized (either by a spin coating, surface tension, or imprinting with a planar mold) and cured to form a solid 804. This layer is etched back until the tops of the resist pillars 805 are exposed, leaving the solid Si-containing material 806 only in the regions between the pillars. The Si-containing material 806 is then used as an etch mask for anisotropic etching of the original resist material 801, which results in holes 807 through the resist material 801 where it was exposed. The Si-containing material 806 is then removed with a selective etch, leaving the resist material 801 as a continuous sheet of material with holes 807 in it wherever the pillars originally were. Finally, this layer is used as an etch mask for etching holes 808 in the substrate 809. After stripping any remaining resist, the process is complete.

These processes describe how to create a positive-tone mirror image replica of a topographic master. These two mirror-image masters may then be used for nanoimprinting both sides of a large number of disks. The imprinted patterns are then used as part of the process to etch pillars on the disk substrates, which is one of the steps in making patterned media.

It should be noted that the process steps to create the mirror image stamper may cause some unintentional degradation of the pattern. However, this image would still be a mirror-image as contemplated by the patentees. Further, intentional degradation of the mirror pattern would also be a mirror-image as contemplated by the patentees.

Discrete track media (DTM), as a subset of patterned media, will also benefit from such a mirror image patterning process. Also, making magnetic masks for contact magnetic transfer servowriting (magnetic imprinting) would benefit from this process as well.

While various embodiments have been described above, it should be understood that the have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A patterned media wherein the patterns on a top and a bottom side of the media are created with the use of a top and a bottom imprinting stampers, the stampers being intentionally nonidentical, and the stampers having been created from a common master pattern.

2. The patterned media of claim 1, wherein the patterns on the distinct top and bottom imprinting stampers are substantially mirror images of one another.

3. The patterned media of claim 1, wherein the patterns on the distinct top and bottom imprinting stampers are mirror images of one another.

4. The patterned media of claim 2, wherein a mirror image pattern is created by imprinting and tone reversal.

5. The patterned media of claim 1, wherein the media is a disk for a hard disk drive.

6. A plurality of stampers for manufacturing a patterned media, wherein the pattern on each of the plurality of stampers are intentionally nonidentical and are created from a common master stamper.

7. The plurality of stampers of claim 6, wherein the pattern of each of the stampers are substantially mirror images of one another.

8. The plurality of stampers of claim 6, wherein the pattern of each of the stampers are mirror images of one another.

9. The plurality of stampers of claim 6, wherein the patterned media is a disk for a hard disk drive.

10. A method for creating a patterned media disk including the steps of:
creating a topographic imprint replica of a first pattern;
creating a negative tone replica of the imprint replica created in the first step; and
creating a disk with a first side of the disk created with the topographic imprint replica and a second side of the disk created with the negative tone replica and
wherein the first and second sides of the disk are substantially mirror images of one another.

11. The method of claim 10, wherein the negative tone replica is created with a planarization tone reversal process.

12. The method of claim 11, wherein the planarization tone reversal process includes the step of dispensing a resist onto a substrate.

13. The method of claim 11, wherein the resist is UV-curable.

14. The method of claim 11, wherein the resist is dispensed with an ink jet.

15. The method of claim 11, further including the step of nanoimprinting the resist with a master mold.

16. The method of claim 15, further including the steps of applying a coating material to the disk and planarizing the disk.

17. The method of claim 16, further including the step of removing the coating material from the disk until the resist is exposed.

18. The method of claim 10, wherein the negative tone replica is created with a lift-off tone reversal process.

19. The method of claim 18, wherein the lift-off tone reversal process includes the step of creating a cured resist pattern on the disk.

20. The method of claim 19, further including the step of removing cured resist from the disk.

21. The method of claim 20, further including the step of depositing an etch mask material on the disk.

22. The method of claim 21, further including the step of removing the resist from the disk.

23. The method of claim 22, further including the step of etching the disk.

24. The method of claim 23, further including the step of etching the disk to leave holes in the surface of the disk.

25. The method of claim 10, wherein the creation of a topographic imprint replica of a first pattern includes the step of imprinting a master on a substrate.
